(19) United States
(12) Patent Application Publication
(10) Pub. No.: US 2006/0260698 A1
(43) Pub. Date: Nov. 23, 2006

(54) Damper accessory mounting system

(76) Inventors: William J. Bailey, Plano, TX (US); Stephen Dane Carey, Smyrna, TN (US)

Correspondence Address: GEORGE A. ROLSTON, 45 SHEPPARD AVE EAST, SUITE 900, TORONTO, ON, M2N5W9, CA

(21) Appl. No.: 11/132,341

(22) Filed: May 19, 2005

(51) Int. Cl. F16K 31/04

(52) U.S. Cl. 137/601.09

(57) ABSTRACT

A damper actuator mounting system having a bracket for coupling a power operated mechanism to an air handling duct, the bracket having a support portion which has a plurality of supporting apertures and a plurality of supporting fasteners, and in which the supporting apertures are adapted to receive the supporting fasteners for adjustably securing and supporting the power operated mechanism, and the bracket having a mounting portion which has mounting fasteners and apertures for securing the bracket to the duct.

### FIELD OF THE INVENTION

The invention relates to air handling equipment such as is used in controlling and or stopping air and smoke or the like flowing in ducts in HVAC systems, and in particular, to a damper actuator mounting system mounting system for mounting actuators and accessories on the exterior of the duct, which connect with the damper within the duct and operate it.

### BACKGROUND OF THE INVENTION

In air duct systems it is well known that dampers must be positioned in the duct system at various locations. The operation of the dampers is such that they close the duct in the event of heat, smoke or fire in the duct. Such dampers have been manufactured in a variety of different designs for many years. Essentially, they provide one blade or a series of blades, with the blades normally being located in planes parallel to the line of air flow in the duct. In the event of an emergency requiring a shut down, the blade or blades are rotated so that they are in planes transverse to the air flow axis and close the duct. Normally such dampers will remain open for extended periods of time. The actual emergency situation which may require the operation of the dampers to close the duct may never occur. During all of this inactivity, which may last for years, the blade or blades are subject to continuous air flow passing through the duct. Dust may accumulate on the blade or blades and on its rotation mechanism. Moisture may be present in the air stream and may eventually lead to the development of corrosion in some parts. If any of these conditions gradually build up to the point where they interfere with the operation of the damper, then it may be impossible for the damper to operate if and when the emergency occurs. In most cases, such dampers are closed by a spring mechanism, and they are held in the open position by means of a heat fusible link. In the event of the link being subjected to heat above a certain temperature, it will melt and the spring will immediately cause closure of the blade or blades. However, if during an extended period of non-use, the blade or blades have been rendered stiff or even immovable, the spring will not function to close it. It is desirable therefore to have periodic checks of such damper mechanisms to ensure that they remain operable during the life of the building. In the past, it has been difficult if not impossible to make such periodic checks without passing heat through the duct and simply melting the links. This means that service personnel must then have access the interior of the ducts through access panels along side the dampers in order to reset them open.

As a result, such periodical checks have not always been carried out at regular intervals, due to the excessive amount of hand labour and down time involved in restoring the system to its normal operation.

Another factor in the operation of such dampers is that if indeed there is an emergency causing closure of the dampers, then when the emergency has been dealt with by building or fire personnel, it is desirable to re-open the dampers as quickly as possible so that the air within the building can be purged and cleansed. If the dampers are simply operated by springs, and if the heat fusible links have disappeared, then each damper must be separately accessed and re-opened and reset by service personnel before such purging can take place. Until purging can be done, the building cannot be re-occupied. As a result, the delay in re-opening and resetting the dampers, prior to purging may result in the building being incapable of being occupied for several days. A further factor is that in many cases the spring operated type of damper was not regarded as entirely satisfactory over extended periods of time. This is because a spring may eventually lose some of its strength while at the same time, the damper accumulates debris of various kinds around its controls so that while the spring becomes weaker the operation of the damper requires more and more force. As a result, it is possible although it has seldom happened, that a damper may become incapable of being closed even when the heat fusible link has melted. In spite of all these problems relating to the use of heat fusible links inside the air ducts, the safety regulations and the entire industry still depend on heat fusible links as the last resort safety measure in the case of an emergency caused by heat, fire or smoke.

Clearly, it is desirable, if it is possible, to provide a damper system which is responsive to excessive heat, fire or smoke, to operate in response to the heat fusible link located in the duct, but in addition, in which the damper blades can be opened and closed by power operated means located outside the duct, whether the heat fusible link is in place or not. Such a system would enable in the first place, the periodic operation of the dampers to ensure that they remained mobile and did not require servicing. In the second place, it would be possible for fire personnel or building supervisors to reopen all of the dampers as soon as an emergency situation is under control so that the entire building interior could be vented and purged by operation of the air handling system without the excessive delays involved in resetting dampers manually in the past. When providing such an improved multi-function damper, it must be borne in mind that the design specifications of a building and, in particular, its HVAC system, will vary significantly even from one floor to another, or from one area to another. Major variations will exist from building to building. In many cases, the dampers are virtually custom made in order to fit the HVAC system at that location in that building. The mounting of all of the equipment necessary to provide damper the functions as described above in an improved multi-function damper, presents a whole new set of problems, when it is applied to the assembly of a damper of almost any dimension, none of which are standard.

### BRIEF SUMMARY OF THE INVENTION

With a view to simplifying the foregoing structures and providing an improved damper system, the invention comprises a damper actuator mounting system which has a bracket for coupling a power operated mechanism to an air handling duct, the bracket comprising a support portion, wherein the support portion including a plurality of supporting apertures and a plurality of supporting fasteners, wherein the supporting apertures are adapted to receive the supporting fasteners for adjustably securing and supporting the power operated mechanism, and a mounting portion, wherein the mounting portion including one or more mounting fasteners and one or more mounting apertures for fixedly securing the bracket to the duct.

Preferably, in accordance with the invention the damper actuator mounting system is mounted on the exterior side of the duct.

Preferably, the bracket has supporting apertures are generally elongate. Furthermore, the supporting apertures preferably include an upper slot portion and a lower-portion having a generally circular shape.

Preferably, there is an electrical enclosure, which may be of channel shape and the bracket may have a flange covering one end of the enclosure.

Preferably, there will be drive shaft apertures in the electrical enclosure and in the bracket, for the drive shaft of the damper to be connected to the power operated mechanism.

Preferably, the bracket of the present invention is made from a single integral piece of material.

In some applications the damper actuator mounting system may incorporate micro switches and actuating cams for operating the micro switches. These switches enable the system to either incorporate position indicators, or to have one or more preset stop points.

Such a system may incorporate a switch mounting plate for mounting the micro switches.

The system may also incorporate a reset mechanism, for manual resetting of the damper.

The various features of novelty which characterize the invention are pointed out with more particularity in the claims annexed to and forming a part of this disclosure. For a better understanding of the invention, its operating advantages and specific objects attained by its use, reference should be made to the accompanying drawings and descriptive matter in which there are illustrated and described preferred embodiments of the invention.

### IN THE DRAWINGS

FIG. 1 is a perspective illustration of typical section of duct work, with a damper installed and showing the damper accessory mounting system and power operated mechanism on the exterior;

FIG. 2 is an exploded schematic perspective of FIG. 1;

FIG. 3 is a perspective illustration of a control box and mounting plate for mounting to a damper;

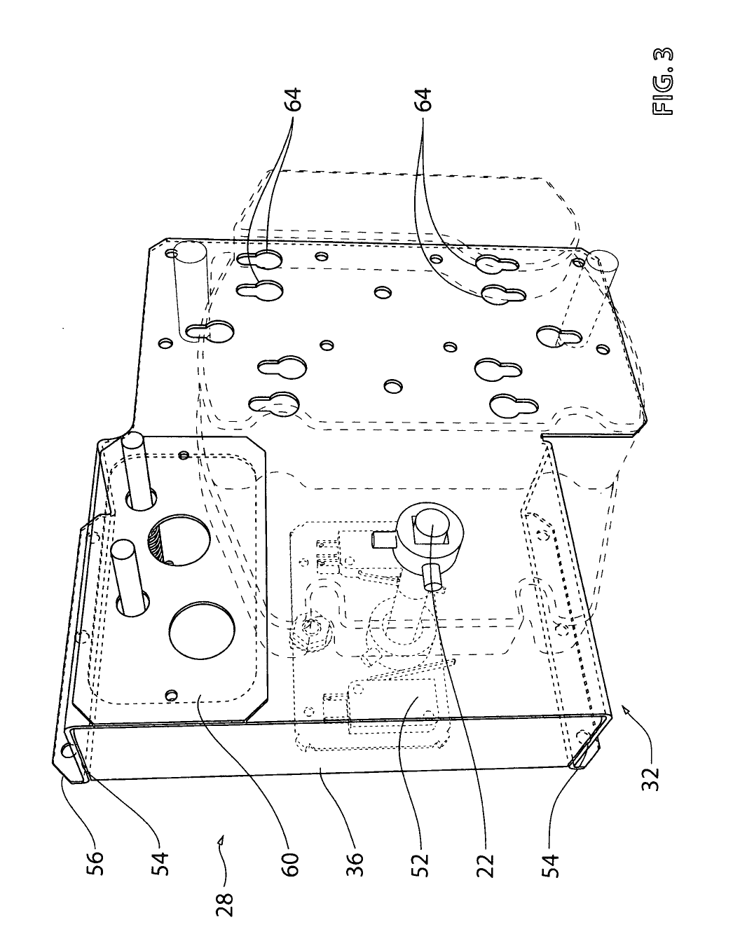

FIG. 4 is an exploded perspective showing the power operated mechanism and the control box partly cut away; and

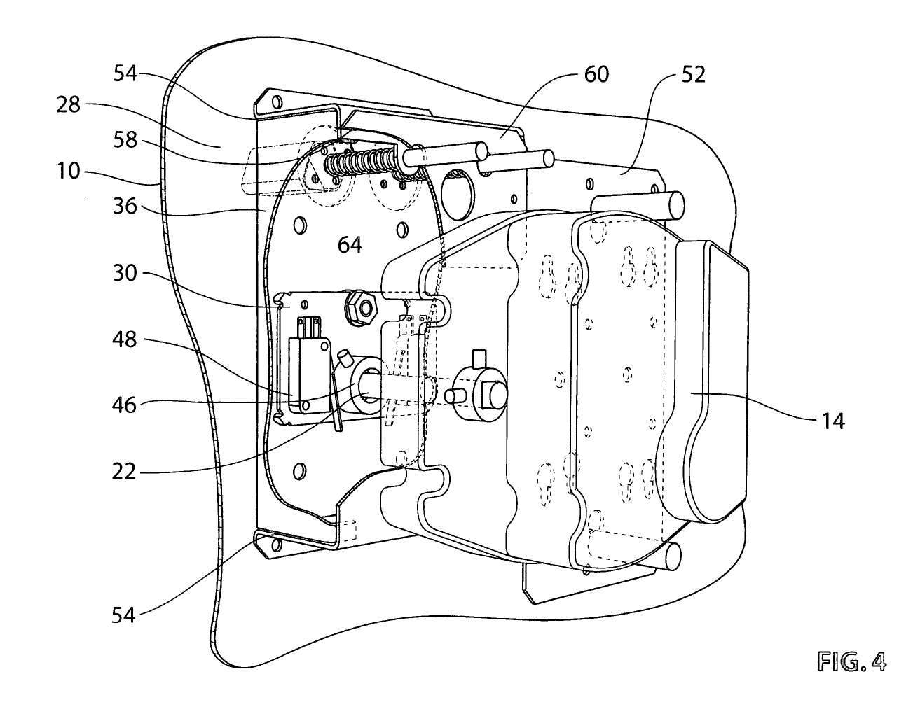

FIG. 5 is an exploded perspective of an alternate embodiment.

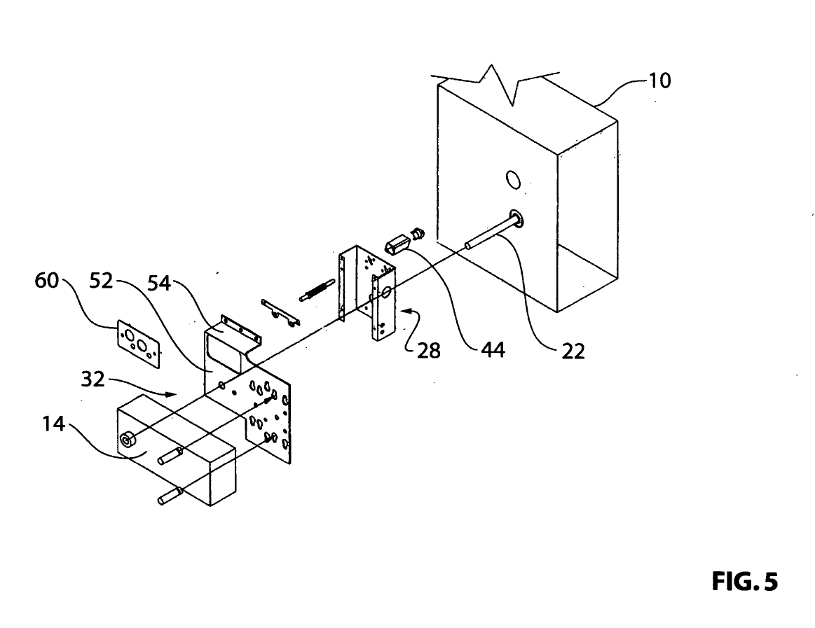

### DESCRIPTION OF A SPECIFIC EMBODIMENT

As has already been described above, the invention relates to air handling duct systems which incorporate dampers. The dampers may be one of a variety of different designs. A popular type of damper incorporates a plurality of blades, which are mounted on a framework within the duct. The blades can be rotated in unison by a single-rotation mechanism between open and closed positions, somewhat in the nature of a blind. Other systems consist of a single plate which is either in a plane aligned with the duct axis (open) or swings transverse to the axis (closed).

As explained above, in the past such dampers have usually been operated by a spring which would cause the mechanism to close the blades. The spring would be held open, under tension, by means of a heat-fusible link located inside the duct. In the event of an emergency, the heat-fusible link would be melted and the spring would operate the mechanism and close the blades.

It is found that it is now desirable to provide for a power system, for example a motor, by which the blades may be operated rather than a simple spring type of operation. This allows the motor powering of the blades to be operated periodically for inspection and testing. It has the added advantage that by periodically rotating the blades to and fro, accumulations of dust and debris which might otherwise obstruct the blade can be loosened and the blades will remain freely rotatable.

As also explained above, such dampers must be made in a wide range of sizes, often being in fact custom made for each location. The construction of dampers with dimensions specific to a height and width location of a particular duct in itself does not present a serious problem. This is done on a daily basis. However, the mounting of the necessary accessories and power means on the exterior of the damper, bearing in mind that the damper may vary greatly in size from one unit to another, does present a difficult problem. In addition, it is known that some construction engineers and local authorities require one form of power operation and another building location may require a different form of power operated mechanisms. Two popular forms of power operated mechanisms are operation by an electrical motor and by a pneumatic motor or cylinder. Other power operated mechanism may also conceivably be applied to the damper unit.

As explained above, the invention is concerned principally with the provision of a mounting system by means of which the various power accessories, valves and power systems can be mounted on the exterior of the damper, by means of what is essentially an all purpose, universal mounting system adaptable to various types of power systems of various different makes and to various dimensions of damper.

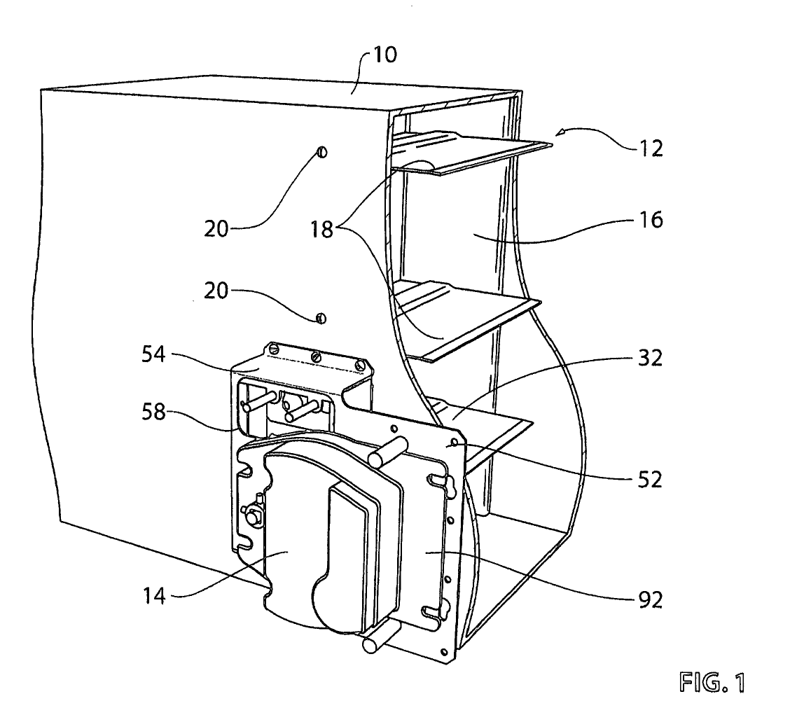

Reference is made to FIG. 1 which shows in general form a length of duct work indicated generally as (10), forming part of a HVAC system, the remainder of which is not shown for the sake of clarity. The duct work (10) is provided with a damper indicated generally as (12). The damper is provided with exterior mounted power operated mechanism indicated as (14). By means of the power operated mechanism (14) the damper (12) can be either opened or closed from a building panel (not shown). In the particular case of this illustration, the operating mechanism (14) is electrically operated. It will be appreciated that the operating system could equally well be operated by a pneumatic cylinder or any other suitable power operated mechanism. This will depend upon the design specifications of the building and the particular requirements of local authorities and the like.

The damper (12) consists essentially of a rectangular mounting frame (16), and a plurality of rotatable damper blades (18) mounted on parallel shafts (20), received within the opposite sides of frame (16). A linkage (not shown) joins all of the blades (18) or the shafts (20), so that operation of the linkage in one direction will open the blades (18) and operation of the linkage in the other direction will close the blades (18), somewhat like a blind or shutter.

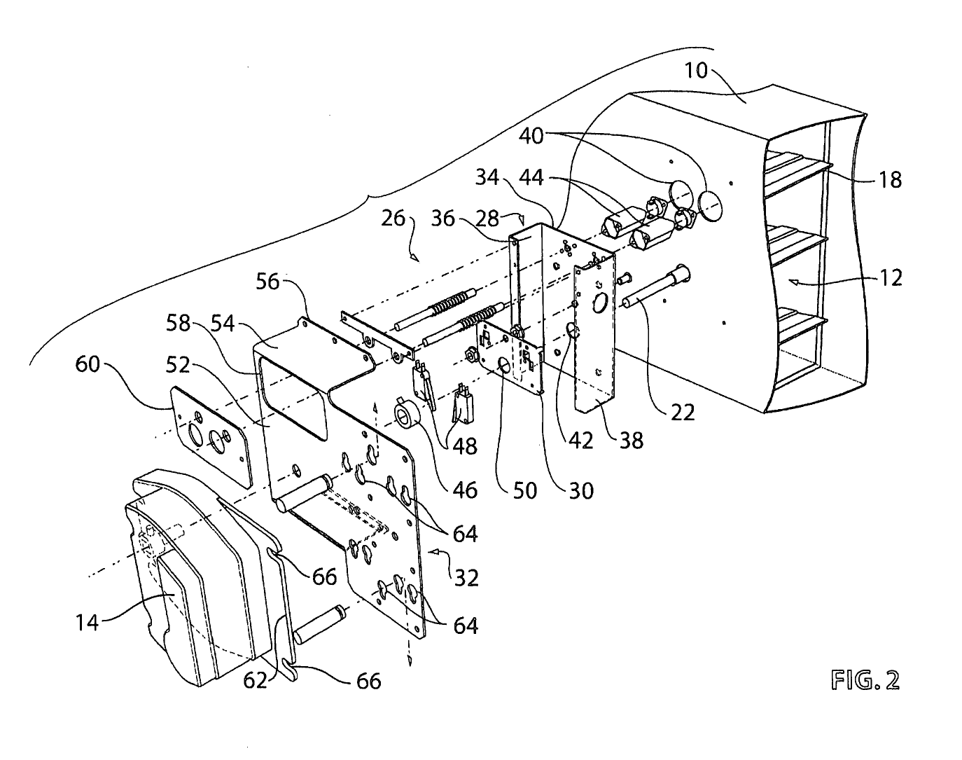

The linkage is operated by a single drive shaft (22). The drive shaft (22) extends through one side of the frame (18) from the interior to the exterior of the duct (10). Also mounted within the damper (12) to the side frame thereof, is a control valve (not shown) and a heat-fusible link (not shown) connected to the control valve (not shown) (FIG. 2). The control valve (not shown) is operated by internal spring means (not shown) and is of a design well known in the art. While reference is made here to a control valve (not shown), it will be appreciated that the control valve may be any suitable control device such as an electrical switch or the like, suitable for use in the environment in the interior of the duct. It will be appreciated that when the heat-fusible link is melted, it releases the valve which can then either open or close an electrical circuit or release pneumatic pressure or whatever other control function is provided by means of the valve or other control device.

Reference is made to FIG. 2 which is an exploded view of showing a damper accessory assembly (26) in accordance with an embodiment of the present invention. The damper accessory assembly (26) is adapted to operably connect the damper (12) to the power operated mechanism (14). The damper accessory assembly (26) is adapted to receive the drive shaft (22) extending from the damper (12), and includes an electrical enclosure (28), a switch plate (30), and a universal mounting bracket (32).

The electrical enclosure (28) includes a web (34) and a pair of channel side walls (36) and (38) which are adapted for mounting to the exterior side of the duct (10). The switch plate (30), is secured with enclosure (28). The electrical enclosure (28) is preferably made from a single sheet of metal formed into the desired shape. The web (34) may have a generally rectangular shape and has a top edge and a bottom edge. One or more valve apertures (40) may be positioned adjacent to the top edge. The valve apertures (40) register with one or more valve openings (50) formed in the side of the duct (10). The valve apertures (40) are adapted to receive at least a portion of the control valves (not shown) extending out from the side of the duct (10).

The web (34) further includes a drive shaft aperture (42) positioned adjacent to the bottom edge. The drive shaft aperture (42) registers with a drive shaft opening formed in the side of the duct (10). The drive shaft aperture (42) is adapted to receive at least a portion of the drive shaft (22) extending out from the damper (10). The valve and drive shaft apertures (40) and (42) may be generally circular, and may be sized to permit easy pass-through of the control valves (not shown) and drive shaft (22), respectively.

One or more thermostats (44) are located within the duct (10). The thermostats (44) are mated to the control valves (not shown) for detecting air temperature changes within the duct (10). The thermostats (44) may also be contained in a thermostat housing to prevent damage occurring to the control valves (not shown) and the thermostats (44). By this design, the control valves (not shown) and thermostats (44) are partially shielded from debris.

The switch plate (30) is positioned adjacent to the web (34) of the electrical enclosure (28). The switch plate (30) is generally rectangular in shape and has an upper edge and a lower edge.

A cam (46) on shaft (22) is operatively connected to one or more switches (48).

The switches (48) are adapted to control the motor (14) so as to open or close the dampers (12) to shut off the duct, in the case of fire or smoke, and/or in some cases to control the air flow within the duct (10). It will be appreciated that the switches (48) may be any suitable on/off switching device capable of activating the electrical motor (14).

An aperture (50) is positioned adjacent to the lower edge of the switch plate (30) for receiving at least a portion of the drive shaft (22).

The universal mounting bracket (32) is preferably formed from a single sheet of metal and is designed to support the power operated mechanism or motor (14). The universal mounting bracket (32) has a mounting portion (52) adapted to support and secure the power operated mechanism or motor (14) relative to the duct (10). The mounting portion (52) is generally L-shaped and includes upper and lower horizontal cover flanges (54) and (54). The horizontal flanges (54) have lip portions (56) having fastener apertures that register with fastener openings formed on the side of the duct (10) adjacent to the top and bottom edge of the electrical enclosure (28). Mounting fasteners pass through the fastener apertures and fastener openings to secure the mounting bracket (32) and electrical enclosure (28) against the exterior side of the duct (10).

It will be appreciated that the bracket (32) may be formed with an access aperture (58) to facilitate periodic maintenance. The access aperture (58) may be covered with an access panel (60) to limit the intrusion of debris into the damper accessory assembly.

The motor (14) connects with of the drive shaft (22) and operates to cause rotational movement of the drive shaft (22)).

The mounting portion (52) of the universal mounting bracket (32) may be generally rectangular in shape and is manufactured to have adequate rigidity to support the weight of the power operated mechanism or motor (14). The mounting portion (52) has a plurality of supporting apertures (64) therethrough which are adapted to receive a plurality of supporting apertures (64) therethrough which are adapted to receive supporting fasteners for supporting and securing the power operated mechanism or motor (14) to the universal mounting bracket (32). It will be appreciated that the spacing of the support apertures (64) may be configured to secure a wide variety of power operated mechanisms.

The support apertures (64) may be of generally elongated keyhole shape, as shown in FIG. (3), having generally circular portions and slotted ends, of a width less than the diameter of the circular ends. This permits the adjustment of the position of the power operated mechanism or motor (14). Such vertical adjustment capability facilitates the secure positioning and support of the power operated mechanism (14) in relation to the universal supporting bracket (32).

The power operated mechanism (14) may include a motor bracket (66) and may be provided with slotted apertures for connection to the universal mounting bracket (32). Fasteners may be used to secure the motor bracket (66) to the universal mounting bracket (32).

The fasteners would first be loosely tightened in the adjustment slots and are slidably positioned along the slots until they may be register with one or more of the supporting apertures formed on the support portion of the universal mounting bracket (32). The fasteners are then passed through the lower portions of the supporting apertures and are adjustably positioned vertically upward into their final position. The fasteners are then tightened to provide a secure connection between the motor bracket and the support portion of universal mounting bracket. It will be noted that the order of operations described above is preferable, but may alternatively be rearranged in any suitable way.

It will be appreciated that the spacing and configuration of the securement apertures formed on the support portion of the universal mounting bracket (32) may be designed to correspond with a wide variety of power operated mechanisms (not shown). By this design, the universal mounting bracket (32) may be utilized to simplify the installation of a wide variety of power operated damper systems. The universal mounting bracket (32) may also be used to retrofit existing damper system with new power operated mechanism with limited disruption and/or remodelling of the subject HVAC system. It will be further appreciated that other types of fasteners may alternatively be used to secure the motor bracket (66) to the universal mounting bracket (32).

Reference is made to FIG. (5), which shows the universal mounting bracket (32) of the present invention in use in one of several different applications. The universal bracket (32) may be used to externally mount all of the equipment necessary to operate a damper system.

The damper system may be activated manually using a remote control panel (not shown) which is operatively connected to the motor (14). The manual activation of the damper system is useful to ensure the proper functioning of the power operated mechanism (14) and to loosen debris obstructing the movement of the damper (12). Alternatively, the damper system may be activated automatically by a fusible link when, for instance, the temperature within the HVAC system exceeds the desired level. The system is primarily designed for FSD (fire/smoke) and SD (smoke) products but can be used with control dampers having an externally mounted Motor/Actuator. The system itself can accommodate most electric and pneumatic damper motors that meet UL 555S.

Several variation on the system can be arranged for differing applications such as:
1. A standard fire/smoke damper system will have the motor mount, motor, and the shaft mounted fuse link and closure spring.
2. A standard smoke damper system will have the motor mount, motor, and the shaft.
3. The system may incorporate a micro switch blade position indication package. The same switch lever arrangement makes contact with micro switches in the electrical enclosure box. As the blade rotates from full open to full closed, the micro switches “make” to indicate the blade position. The damper fails shut using the shaft mounted fuse link and closure spring.

Other variations are possible using combinations of the foregoing to meet requirements in various situations.

The foregoing is a description of a preferred embodiment of the invention which is given here by way of example only. The invention is not to be taken as limited to any of the specific features as described, but comprehends all such variations thereof as come within the scope of the appended claims.

What is claimed is:

1. A damper actuator mounting system for coupling a power operated mechanism to an air handling duct, for operating a damper within the duct and comprising:
a bracket;
a support portion of said bracket, wherein said support portion includes a plurality of supporting apertures and a plurality of supporting fasteners, wherein said supporting apertures are adapted to receive said supporting fasteners for adjustably securing and supporting said power operated mechanism; and
a mounting portion of said bracket, wherein said mounting portion includes one or more mounting apertures for fixedly securing said bracket to said duct.

2. A damper actuator mounting system as claimed in claim 1, wherein said bracket defines said mounting plate portion and further defines a cover portion at right angles thereto.

3. A damper actuator mounting system as claimed in claim 2, wherein said cover portion interfits with an electrical enclosure, for covering one end thereof.

4. A damper actuator mounting system as claimed in claim 1, wherein said supporting apertures in said mounting plate include an upper slotted portion and a lower portion having a generally circular shape.

5. A damper actuator mounting system as claimed in claim 4, wherein the width of said upper portion is less than said lower portion.

6. A damper actuator mounting system as claimed in claim 3 including a switch plate between said bracket and said electrical enclosure.

7. A damper actuator mounting system as claimed in claim 6, wherein said switch plate defines a drive shaft aperture.

8. A damper actuator mounting system as claimed in claim 7, wherein said bracket defines a switch plate access opening.

9. A damper actuating assembly for connecting a damper in an air duct system to a power operated mechanism, said damper actuating assembly comprising:
a drive shaft, wherein said drive shaft is rotatably connected to said damper;
one or more control valves, wherein said control valves are adapted to switch from an inoperable position to an operable position;
an electrical enclosure, wherein said electrical enclosure is adapted to receive at least a portion of said drive shaft and at least a portion of said control valves;
a switch plate, and including one or more switches on said plate connected to said control valves, wherein said switches are adapted to to activate said power operated mechanism when said control valves are an operable position;
a universal mounting bracket, wherein said universal mounting bracket is secured to said switch plate, and further wherein said universal mounting bracket is adapted for securing said power operated mechanism to said duct;
and said power operated mechanism being connected to rotatably move said drive shaft, wherein the rotation of said drive shaft closes or opens said damper.

10. The damper actuating assembly as claimed in claim 9 wherein said bracket defines a shaft opening for said drive shaft.

11. The damper actuating as claimed in claim 10, wherein said bracket defines thermostat openings for receiving thermostats, connected to said duct.

12. The damper actuating assembly as claimed in claim 11, wherein said bracket defines a cover portion overlying said electrical enclosure.

13. The damper actuating assembly as claimed in claim 12, wherein said electrical enclosure is of channel shaped construction.

14. The damper actuating assembly as claimed in claim 9 including a switch plate between said bracket and said electrical enclosure.

15. The damper actuating assembly as claimed in claim 14 wherein said bracket defines a switch access opening.

16. The damper actuating assembly as claimed in claim 15 including a cover for said switch access opening.
